(19) United States
(12) Patent Application Publication
(10) Pub. No.: US 2011/0220550 A1
(43) Pub. Date: Sep. 15, 2011

(54) MILD HYDRODESULFURIZATION INTEGRATING TARGETED OXIDATIVE DESULFURIZATION TO PRODUCE DIESEL FUEL HAVING AN ULTRA-LOW LEVEL OF ORGANOSULFUR COMPOUNDS

(76) Inventors: Abdennour BOURANE, Ras Tanura (SA); Omer Refa Koseoglu, Dharan (SA); Mohammed Ibrahim Katheeri, Dammam (SA)

(21) Appl. No.: 12/724,300

(22) Filed: Mar. 15, 2010

(51) Int. Cl. C10G 45/00; B01J 8/00

(52) U.S. Cl. 208/212; 422/187

(57) ABSTRACT

Deep desulfurization of hydrocarbon feeds containing undesired organosulfur compounds to produce a hydrocarbon product having low levels of sulfur, i.e., 15 ppmw or less of sulfur, is achieved by first contacting the entire feed with a hydrodesulfurization catalyst in a hydrodesulfurization reaction zone operating under mild conditions to remove the labile organosulfur compounds. A flashing column downstream of the hydrodesulfurization reaction zone fractionates the effluent at a target cut point temperature to obtain two hydrocarbon fuel fractions. A first fraction boiling at or above the target cut point temperature contains the remaining refractory organosulfur compounds. A second fraction boiling below the target cut point temperature is substantially free of organosulfur compounds, since the organosulfur compounds boiling in the range of this fraction were the labile organosulfur compounds which were initially removed by mild hydrodesulfurization. The first fraction is contacted with an oxidizing agent and an active metal catalyst in an oxidation reaction zone to convert the refractory organosulfur compounds to oxidized organosulfur compounds. These oxidized organosulfur compounds are subsequently removed, producing a stream containing an ultra-low level of organosulfur compounds. The two streams can be combined to obtain a full range hydrocarbon product having an ultra-low level of organosulfur compounds.

### RELATED APPLICATIONS

Not applicable

### BACKGROUND OF THE INVENTION

1. Field of the Invention

The present invention relates to integrated oxidative desulfurization processes to efficiently reduce the sulfur content of hydrocarbons, and more particularly to the deep desulfurization of hydrocarbons, including diesel fuel, to produce fuels having ultra-low sulfur levels.

2. Description of Related Art

The discharge into the atmosphere of sulfur compounds during processing and end-use of the petroleum products derived from sulfur-containing sour crude oil pose health and environmental problems. The stringent reduced-sulfur specifications applicable to transportation and other fuel products have impacted the refining industry, and it is necessary for refiners to make capital investments to greatly reduce the sulfur content in gas oils to 10 parts per million by weight (ppmw) or less. In the industrialized nations such as the United States, Japan and the countries of the European Union, refineries for transportation fuel have already been required to produce environmentally clean transportation fuels. For instance, in 2007 the United States Environmental Protection Agency required the sulfur content of highway diesel fuel to be reduced 97%, from 500 ppmw (low sulfur diesel) to 15 ppmw (ultra-low sulfur diesel). The European Union has enacted even more stringent standards, requiring diesel and gasoline fuels sold in 2009 to contain less than 10 ppmw of sulfur. Other countries are following in the footsteps of the United States and the European Union and are moving forward with regulations that will require refineries to produce transportation fuels with an ultra-low sulfur level.

To keep pace with recent trends toward production of ultra-low sulfur fuels, refiners must choose among the processes or crude oils that provide flexibility that ensures future specifications are met with minimum additional capital investment, in many instances by utilizing existing equipment. Conventional technologies such as hydrocracking and two-stage hydrotreating offer solutions to refiners for the production of clean transportation fuels. These technologies are available and can be applied as new grassroots production facilities are constructed. However, many existing hydroprocessing facilities, such as those using relatively low pressure hydrotreaters, represent a substantial prior investment and were constructed before these more stringent sulfur reduction requirements were enacted. It is very difficult to upgrade existing hydrotreating reactors in these facilities because of the comparatively more severe operational requirements (i.e., higher temperature and pressure) to obtain clean fuel production. Available retrofitting options for refiners include elevation of the hydrogen partial pressure by increasing the recycle gas quality, utilization of more active catalyst compositions, installation of improved reactor components to enhance liquid-solid contact, the increase of reactor volume, and the increase of the feedstock quality.

There are many hydrotreating units installed worldwide producing transportation fuels containing 500-3000 ppmw sulfur. These units were designed for, and are being operated at, relatively milder conditions (i.e., low hydrogen partial pressures of 30 kilograms per square centimeter for straight run gas oils boiling in the range of 180C.°-370° C.).

However, with the increasing prevalence of more stringent environmental sulfur specifications in transportation fuels mentioned above, the maximum allowable sulfur levels are being reduced to no greater than 15 ppmw, and in some cases no greater than 10 ppmw. This ultra-low level of sulfur in the end product typically requires either construction of new high pressure hydrotreating units, or a substantial retrofitting of existing facilities, e.g., by integrating new reactors, incorporating gas purification systems, reengineering the internal configuration and components of reactors, and/or deployment of more active catalyst compositions.

Sulfur-containing compounds that are typically present in hydrocarbon fuels include aliphatic molecules such as sulfides, disulfides and mercaptans as well as aromatic molecules such as thiophene, benzothiophene and its long chain alkylated derivatives, and dibenzothiophene and its alkyl derivatives such as 4,6-dimethyl-dibenzothiophene. Aromatic sulfur-containing molecules have a higher boiling point than aliphatic sulfur-containing molecules, and are consequently more abundant in higher boiling fractions.

In addition, certain fractions of gas oils possess different properties. The following table illustrates the properties of light and heavy gas oils derived from Arabian Light crude oil:

TABLE 1

| Feedstock Name | | Light | Heavy |
|---|---|---|---|
| Blending Ratio | | — | — |
| API Gravity | ° | 37.5 | 30.5 |
| Carbon | W % | 85.99 | 85.89 |
| Hydrogen | W % | 13.07 | 12.62 |
| Sulfur | W % | 0.95 | 1.65 |
| Nitrogen | ppmw | 42 | 225 |
| ASTM D86 Distillation | | | |
| IBP/5 V % | ° C. | 189/228 | 147/244 |
| 10/30 V % | ° C. | 232/258 | 276/321 |
| 50/70 V % | ° C. | 276/296 | 349/373 |
| 85/90 V % | ° C. | 319/330 | 392/398 |
| 95 V % | ° C. | 347 | |
| Sulfur Speciation | | | |
| Organosulfur Compounds | ppmw | 4591 | 3923 |
| Boiling Less than 310° C. | | | |
| Dibenzothiophenes | ppmw | 1041 | 2256 |
| C₁-Dibenzothiophenes | ppmw | 1441 | 2239 |
| C₂-Dibenzothiophenes | ppmw | 1325 | 2712 |
| C₃-Dibenzothiophenes | ppmw | 1104 | 5370 |

As set forth above in Table 1, the light and heavy gas oil fractions have ASTM D85 95 V % point of 319° C. and 392° C., respectively. Further, the light gas oil fraction contains less sulfur and nitrogen than the heavy gas oil fraction (0.95 W % sulfur as compared to 1.65 W % sulfur and 42 ppmw nitrogen as compared to 225 ppmw nitrogen).

Advanced analytical techniques such as multi-dimensional gas chromatography (Hua R., Li Y., Liu W., Zheng J., Wei H., Wang J., LU X., Lu X., Kong H., Xu G., Journal of Chromatography A, 1019 (2003)101-109) with a sulfur chemiluminescence detector, have shown that the middle distillate cut boiling in the range of 170-400° C. contains sulfur species including thiols, sulfides, disulfides, thiophenes, benzothiophenes, dibenzothiophenes, and benzonaphthothiophenes, with and without alkyl substituents.

The sulfur specification and content of light and heavy gas oils are conventionally analyzed by two methods. In the first method, sulfur species are categorized based on structural groups. The structural groups include one group having sulfur-containing compounds boiling at less than 310° C., including dibenzothiophenes and its alkylated isomers, and another group including 1-, 2- and 3-methyl-substituted dibenzothiophenes, denoted as C₁, C₂ and C₃, respectively. Base on this method, the heavy gas oil fraction contains more alkylated di-benzothiophene molecules than the light gas oils.

In the second method of analyzing sulfur content of light and heavy gas oils, and referring to FIG. 1, the cumulative sulfur concentrations are plotted against the boiling points of the sulfur-containing compounds to observe concentration variations and trends. Note that the boiling points depicted are those of detected sulfur-containing compounds, rather than the boiling point of the total hydrocarbon mixture. The boiling point of the key sulfur-containing compounds consisting of dibenzothiophenes, 4-methydibenzothiophenes and 4,6-dimethyldibenzothiophenes are also shown in FIG. 1 for convenience. The cumulative sulfur specification curves show that the heavy gas oil fraction contains a higher content of heavier sulfur-containing compounds and lower content of lighter sulfur-containing compounds as compared to the light gas oil fraction. For example, it is found that 5370 ppmw of C₃-dibenzothiophene, and bulkier molecules such as benzonaphthothiophenes, are present in the heavy gas oil fraction, compared to 1104 ppmw in the light gas oil fraction. In contrast, the light gas oil fraction contains a higher content of light sulfur-containing compounds compared to heavy gas oil. Light sulfur-containing compounds are structurally less bulky than dibenzothiophenes and boil at less than 310° C. Also, twice as much C₁ and C₂ alkyl-substituted dibenzothiophenes exist in the heavy gas oil fraction as compared to the light gas oil fraction.

Aliphatic sulfur-containing compounds are more easily desulfurized (labile) using conventional hydrodesulfurization methods. However, certain highly branched aliphatic molecules can hinder the sulfur atom removal and are moderately more difficult to desulfurize (refractory) using conventional hydrodesulfurization methods.

Among the sulfur-containing aromatic compounds, thiophenes and benzothiophenes are relatively easy to hydrodesulfurize. The addition of alkyl groups to the ring compounds increases the difficulty of hydrodesulfurization. Dibenzothiophenes resulting from addition of another ring to the benzothiophene family are even more difficult to desulfurize, and the difficulty varies greatly according to their alkyl substitution, with di-beta substitution being the most difficult to desulfurize, thus justifying their “refractory” appellation. These beta substituents hinder exposure of the heteroatom to the active site on the catalyst.

The economical removal of refractory sulfur-containing compounds is therefore exceedingly difficult to achieve, and accordingly removal of sulfur-containing compounds in hydrocarbon fuels to an ultra-low sulfur level is very costly by current hydrotreating techniques. When previous regulations permitted sulfur levels up to 500 ppmw, there was little need or incentive to desulfurize beyond the capabilities of conventional hydrodesulfurization, and hence the refractory sulfur-containing compounds were not targeted. However, in order to meet the more stringent sulfur specifications, these refractory sulfur-containing compounds must be substantially removed from hydrocarbon fuels streams.

Relative reactivities of sulfur-containing compounds based on their first order reaction rates at 250° C. and 300° C. and 40.7 Kg/cm² hydrogen partial pressure over Ni—Mo/alumina catalyst, and activation energies, are given in Table 2 (Steiner P. and Blekkan E. A., Fuel Processing Technology 79 (2002)1-12).

TABLE 2

| | | 4-methy-dibenzo- | 4,6-dimethy- |
|---|---|---|---|
| Name | Dibenzothiophene | thiophene | dibenzo-thiophene |
| Structure | 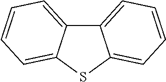 | 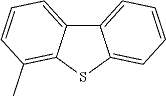 | 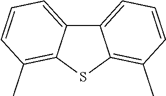 |
| Reactivity k_{@250}, s⁻¹ | 57.7 | 10.4 | 1.0 |
| Reactivity k_{@300}, s⁻¹ | 7.3 | 2.5 | 1.0 |
| Activation Energy | 28.7 | 36.1 | 53.0 |
| Eₐ, Kcal/mol | | | |

As is apparent from Table 2, dibenzothiophene is 57 times more reactive than the refractory 4,6-dimethyldibenzothiphene at 250° C. The relative reactivity decreases with increasing operating severity. With a 50° C. temperature increase, the relative reactivity of di-benzothiophene compared to 4,6-dibenzothiophene decreases to 7.3 from 57.7.

The development of non-catalytic processes for desulfurization of petroleum distillate feedstocks has been widely studied, and certain conventional approaches are based on oxidation of sulfur-containing compounds are described, e.g., in U.S. Pat. Nos. 5,910,440, 5,824,207, 5,753,102, 3,341,448 and 2,749,284.

Oxidative desulfurization as applied to middle distillates is attractive for several reasons. First, mild reaction conditions, e.g., temperature from room temperature up to 200° C. and pressure from 1 up to 15 atmospheres, are normally used, thereby resulting a priori in reasonable investment and operational costs, especially for hydrogen consumption which is usually expensive. Another attractive aspect is related to the reactivity of high aromatic sulfur-containing species. This is evident since the high electron density at the sulfur atom caused by the attached electron-rich aromatic rings, which is further increased with the presence of additional alkyl groups on the aromatic rings, will favor its electrophilic attack as shown in Table 3 (S. Otsuki, T. Nonaka, N. Takashima, W. Qian, A. Ishihara, T. Imai and T. Kabe, Energy Fuels 14 (2000) 1232). However, the intrinsic reactivity of molecules such as 4,6-DMBT should be substantially higher than that of DBT, which is much easier to desulfurize by hydrodesulfurization.

TABLE 3
Electron Density of selected sulfur species

| | | Electron | K (L/ |
|---|---|---|---|
| Sulfur compound | Formulas | Density | (mol · min)) |
| Thiophenol | 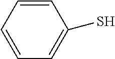 | 5.902 | 0.270 |
| Methyl Phenyl Sulfide | 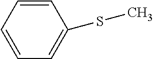 | 5.915 | 0.295 |
| Diphenyl Sulfide | 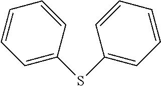 | 5.860 | 0.156 |
| 4,6-DMDBT | 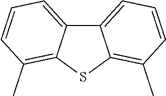 | 5.760 | 0.0767 |
| 4-MDBT | 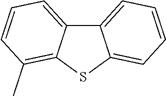 | 5.759 | 0.0627 |
| Dibenzothiophene | 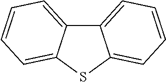 | 5.758 | 0.0460 |
| Benzothiophene | 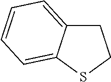 | 5.739 | 0.00574 |
| 2,5- Dimethylthiophene | 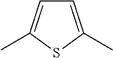 | 5.716 | — |
| 2-methylthiophene | 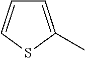 | 5.706 | — |
| Thiophene | 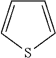 | 5.696 | — |

Certain existing desulfurization processes incorporate both hydrodesulfurization and oxidative desulfurization. For instance, Cabrera et al. U.S. Pat. No. 6,171,478 describes an integrated process in which the hydrocarbon feedstock is first contacted with a hydrodesulfurization catalyst in a hydrodesulfurization reaction zone to reduce the content of certain sulfur-containing molecules. The resulting hydrocarbon stream is then sent in its entirety to an oxidation zone containing an oxidizing agent where residual sulfur-containing compounds are converted into oxidized sulfur-containing compounds. After decomposing the residual oxidizing agent, the oxidized sulfur-containing compounds are solvent extracted, resulting in a stream of oxidized sulfur-containing compounds and a reduced-sulfur hydrocarbon oil stream. A final step of adsorption is carried out on the latter stream to further reduce the sulfur level.

Kocal U.S. Pat. No. 6,277,271 also discloses a desulfurization process integrating hydrodesulfurization and oxidative desulfurization. A stream composed of sulfur-containing hydrocarbons and a recycle stream containing oxidized sulfur-containing compounds is introduced in a hydrodesulfurization reaction zone and contacted with a hydrodesulfurization catalyst. The resulting hydrocarbon stream containing a reduced sulfur level is contacted in its entirety with an oxidizing agent in an oxidation reaction zone to convert the residual sulfur-containing compounds into oxidized sulfur-containing compounds. The oxidized sulfur-containing compounds are removed in one stream and a second stream of hydrocarbons having a reduced concentration of oxidized sulfur-containing compounds is recovered. Like the process in Cabrera et al., the entire hydrodesulfurized effluent is subjected to oxidation in the Kocal process.

Wittenbrink et al. U.S. Pat. No. 6,087,544 discloses a desulfurization process in which a distillate feedstream is first fractionated into a light fraction containing from about 50 to 100 ppm of sulfur, and a heavy fraction. The light fraction is passed to a hydrodesulfurization reaction zone. Part of the desulfurized light fraction is then blended with half of the heavy fraction to produce a low sulfur distillate fuel. However, not all of the distillate feedstream is recovered to obtain the low sulfur distillate fuel product, resulting in a substantial loss of high quality product yield.

Rappas et al. PCT Publication WO02/18518 discloses a two-stage desulfurization process located downstream of a hydrotreater. After having been hydrotreated in a hydrodesulfurization reaction zone, the entire distillate feedstream is introduced to an oxidation reaction zone to undergo biphasic oxidation in an aqueous solution of formic acid and hydrogen peroxide. Thiophenic sulfur-containing compounds are converted to corresponding sulfones. Some of the sulfones are retained in the aqueous solution during the oxidation reaction, and must be removed by a subsequent phase separation step. The oil phase containing the remaining sulfones is subjected to a liquid-liquid extraction step. In the process of WO02/18518, like Cabrera et al. and Kocal, the entire hydrodesulfurized effluent is subject to oxidation reactions, in this case biphasic oxidation.

Levy et al. PCT Publication WO03/014266 discloses a desulfurization process in which a hydrocarbon stream having sulfur-containing compounds is first introduced to an oxidation reaction zone. Sulfur-containing compounds are oxidized into the corresponding sulfones using an aqueous oxidizing agent. After separating the aqueous oxidizing agent from the hydrocarbon phase, the resulting hydrocarbon stream is passed to a hydrodesulfurization step. In the process of WO03/014266, the entire effluent of the oxidation reaction zone is subject to hydrodesulfurization.

Gong et al. U.S. Pat. No. 6,827,845 discloses a three-step process for removal of sulfur- and nitrogen-containing compounds in a hydrocarbon feedstock. All or a portion of the feedstock is a product of a hydrotreating process. In the first step, the feed is introduced to an oxidation reaction zone containing peracid that is free of catalytically active metals. Next, the oxidized hydrocarbons are separated from the acetic acid phase containing oxidized sulfur and nitrogen compounds. In this reference, a portion of the stream is subject to oxidation. The highest cut point identified is 316° C. In addition, this reference explicitly avoids catalytically active metals in the oxidation zone, which necessitates an increased quantity of peracid and more severe operating conditions. For instance, the H₂O₂:S molar ratio in one of the examples is 640, which is extremely high as compared to oxidative desulfurization with a catalytic system.

Gong et al. U.S. Pat. No. 7,252,756 discloses a process for reducing the amount of sulfur- and/or nitrogen-containing compounds for refinery blending of transportation fuels. A hydrocarbon feedstock is contacted with an immiscible phase containing hydrogen peroxide and acetic acid in an oxidation zone. After a gravity phase separation, the oxidized impurities are extracted with aqueous acetic acid. A hydrocarbon stream having reduced impurities is recovered, and the acetic acid phase effluents from the oxidation and the extraction zones are passed to a common separation zone for recovery of the acetic acid. In an optional embodiment of U.S. Pat. No. 7,252,756, the feedstock to the oxidation process can be a low-boiling component of a hydrotreated distillate. This reference contemplates subjecting the low boiling fraction to the oxidation zone.

None of the above-mentioned references describe a suitable and cost-effective process for desulfurization of hydrocarbon fuel fractions with specific sub-processes and apparatus for targeting different organosulfur compounds. In particular, conventional methods do not fractionate a hydrocarbon fuel stream into fractions containing different classes of sulfur-containing compounds with different reactivities relative to the conditions of hydrodesulfurization and oxidative desulfurization. Conventionally, most approaches subject the entire gas oil stream to the oxidation reactions, requiring unit operations that must be appropriately dimensioned to accommodate the full process flow.

Therefore, a need exists for an efficient and effective process and apparatus for desulfurization of hydrocarbon fuels to an ultra-low sulfur level.

Accordingly, it is an object of the present invention to desulfurize a hydrocarbon fuel stream containing different classes of sulfur-containing compounds having different reactivities, utilizing reactions separately directed to labile and refractory classes of sulfur-containing compounds.

It is a further object of the present invention to produce hydrocarbon fuels having an ultra-low sulfur level by integrating mild hydrodesulfurization and targeted oxidative desulfurization of refractory organosulfur compounds.

As used herein in relation to the apparatus and process of the present invention, the term “labile organosulfur compounds” means organosulfur compounds that can be easily desulfurized under relatively mild hydrodesulfurization pressure and temperature conditions, and the term “refractory organosulfur compounds” means organosulfur compounds that are relatively more difficult to desulfurize under mild hydrodesulfurization conditions.

Additionally, as used herein in relation to the apparatus and process of the present invention, the terms “mild hydrodesulfurization” and “mild operating conditions” when used in reference to hydrodesulfurization of a mid-distillate stream, i.e., boiling in the range of about 180° C. to about 370° C., generally means hydrodesulfurization processes operating at: a temperature of about 300° C. to about 400° C., preferably about 320° C. to about 380° C.; a reaction pressure of about 20 bars to about 100 bars, preferably about 30 bars to about 60 bars; a hydrogen partial pressure of below about 55 bars, preferably about 25 bars to about 40 bars; a feed rate of about 0.5 hr⁻¹ to about 10 hr⁻¹, preferably about 1.0 hr⁻¹ to about 4 hr⁻¹; and a hydrogen feed rate of about 100 liters of hydrogen per liter of oil (L/L) to about 1000 L/L, preferably about 200 L/L to about 300 L/L.

### SUMMARY OF THE INVENTION

The above objects and further advantages are provided by the apparatus and process for desulfurization of hydrocarbon feeds containing both refractory and labile organosulfur compounds by mild hydrodesulfurization of a fuel stream to remove labile organosulfur compounds and oxidative desulfurization of a targeted fraction to remove refractory organosulfur compounds.

According to the present invention, a cost-effective apparatus and process for reduction of sulfur levels of hydrocarbon streams includes integration of hydrodesulfurization with an oxidation reaction zone, in which the hydrocarbon sulfur-containing compounds are converted by oxidation to compounds containing sulfur and oxygen, such as sulfoxides or sulfones. The oxidized sulfur-containing compounds have different chemical and physical properties, which facilitate their removal from the balance of the hydrocarbon stream. Oxidized sulfur-containing compounds can be removed by extraction, distillation and/or adsorption.

The present invention comprehends an integrated system and process that is capable of efficiently and cost-effectively reducing the organosulfur content of hydrocarbon fuels. The cost of hydrotreating is minimized by operating under relatively mild temperature and pressure conditions. Deep desulfurization of hydrocarbon fuels according to the present invention effectively optimizes use of integrated apparatus and processes, combining mild hydrodesulfurization and oxidative desulfurization. Most importantly, using the apparatus and process of the present invention, refiners can adapt existing hydrodesulfurization equipment and run such equipment under mild operating conditions. Accordingly hydrocarbon fuels are economically desulfurized to an ultra-low level.

Deep desulfurization of hydrocarbon feedstreams is achieved by first contacting the entire fuel stream with a hydrodesulfurization catalyst in a hydrodesulfurization reaction zone operating at mild conditions to remove labile organosulfur compounds. A flashing column downstream of the hydrodesulfurization reaction zone fractionates the hydrotreated effluent at a target cut point temperature to obtain two hydrocarbon fuel fractions. The organosulfur compounds in the first fraction, boiling at or above the target cut point temperature contains the remaining refractory organosulfur compounds, including 4,6-dimethyldibenzothiophene and its derivatives. A second fraction boiling below the target cut point temperature is substantially free of organosulfur compounds, since the organosulfur compounds boiling in the range of this fraction were the labile organosulfur compounds which were removed in the mild hydrodesulfurization step. The first fraction is contacted with an oxidizing agent and an active metal catalyst in an oxidation reaction zone to convert the refractory organosulfur compounds into oxidized organosulfur compounds. These oxidized organosulfur compounds are subsequently removed, producing a hydrocarbon product stream that contains an ultra-low level of organosulfur compounds. The two streams can be combined to obtain a full range hydrocarbon product containing an ultra-low level of organosulfur compounds.

The inclusion of a flashing column in an integrated system and process combining hydrodesulfurization and oxidative desulfurization allows a partition of the different classes of sulfur-containing compounds according to their respective reactivity factors, thereby optimizing utilization of the different types of desulfurization processes and hence resulting in a more cost effective process. The volumetric/mass flow through the oxidation reaction zone is reduced, since only the fraction of the original feedstream containing refractory sulfur-containing compounds is subjected to the oxidation process. As a result, the requisite equipment capacity, and accordingly both the capital equipment cost and the operating costs, are minimized. In addition, the total hydrocarbon stream is not subjected to oxidation reactions, thus avoiding unnecessary oxidation of organosulfur compounds that are otherwise desulfurized using mild hydrodesulfurization, which also minimizes the requirement to remove these oxidized organosulfur compounds.

Furthermore, product quality is improved by the integrated process of the present invention since undesired side reactions associated with oxidation of the entire feedstream under generally harsh conditions are avoided.

### BRIEF DESCRIPTION OF THE DRAWINGS

The foregoing summary, as well as the following detailed description of preferred embodiments of the invention will be best understood when read in conjunction with the attached drawings. For the purpose of illustrating the invention, there are shown in the drawings embodiments which are presently preferred. It should be understood, however, that the invention is not limited to the precise arrangements and apparatus shown. In the drawings the same numeral is used to refer to the same or similar elements, in which:

FIG. 1 is a graph showing cumulative sulfur concentrations plotted against boiling points of three thiophenic compounds;

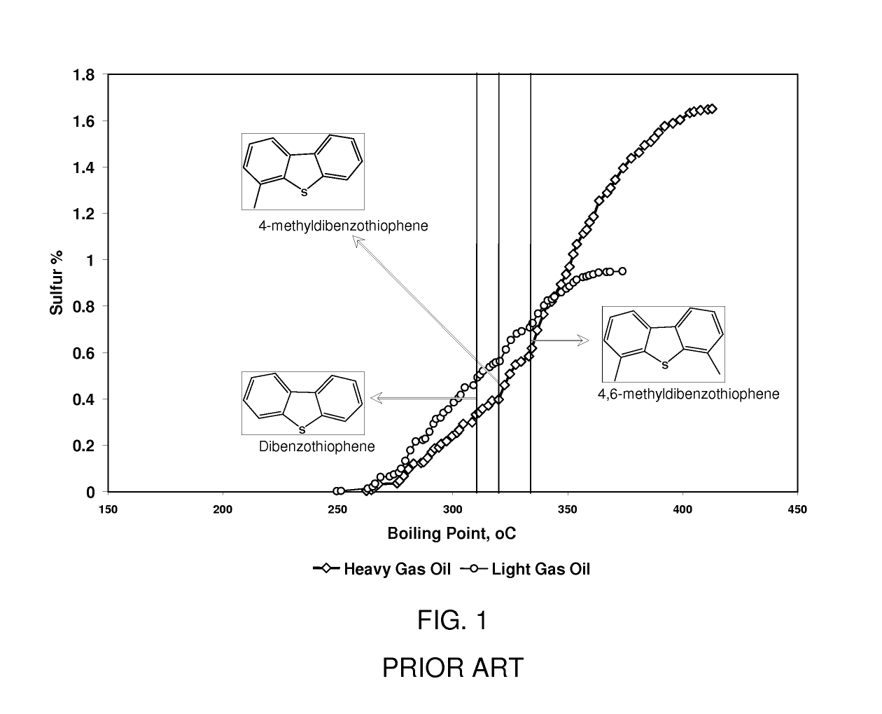

FIG. 2 is a schematic diagram of an integrated desulfurization system and process of the present invention that includes a flashing column between a hydrodesulfurization zone and an oxidative desulfurization zone; and

FIG. 3 is a schematic diagram of a separation apparatus for removing oxidized organosulfur compounds from a fraction boiling at or above the target cut point temperature according to the system and process of the present invention.

### DETAILED DESCRIPTION OF THE INVENTION

The present invention comprehends an integrated desulfurization process to produce hydrocarbon fuels with ultra-low levels of organosulfur compounds. The process includes the following steps:

a. Contacting the hydrocarbon stream in its entirety with a hydrotreating catalyst in a hydrodesulfurization reaction zone under mild operating conditions.

b. Flashing the effluent hydrotreated stream at a target cut point temperature of about 320° C. to about 360° C., preferably about 340° C., to obtain two fractions.

c. The fraction boiling below the target cut point temperature is substantially free of organosulfur compounds since the labile organosulfur compounds were converted during the hydrodesulfurization step.

d. The organosulfur compounds in the fraction boiling at or above the target cut point temperature are primarily refractory organosulfur compounds, including aromatic molecules such as certain benzothiophenes e.g., long chain alkylated benzothiophenes), dibenzothiophene and alkyl derivatives, e.g., 4,6-dimethyldibenzothiophene. This fraction is contacted with an oxidizing agent and a metal catalyst in an oxidation reaction zone to convert the organosulfur compounds into oxidized sulfur-containing compounds.

e. The oxidized organosulfur compounds are subsequently removed in a separation zone, by oxidation product removal processes and apparatus that include extraction, distillation, adsorption, or combined processes comprising one or more of extraction, distillation and adsorption.

f. The flashing column effluent fraction boiling below the target cut point temperature and the stream from the separation zone can be recombined to produce an ultra-low sulfur level hydrocarbon product, e.g., a full-range diesel fuel product.

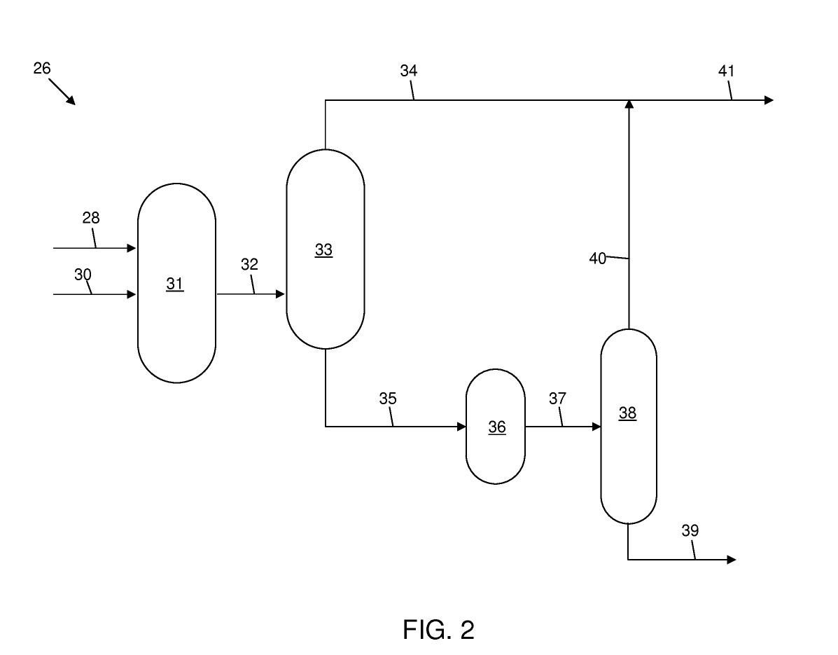

Referring now to FIG. 2, an integrated desulfurization apparatus 26 according to the present invention is schematically illustrated. Apparatus 26 includes a hydrodesulfurization reaction zone 31, a flashing column 33, an oxidative desulfurization reaction zone 36 and a separation zone 38. A hydrocarbon stream 30 is introduced to the hydrodesulfurization reaction zone 31 and into contact with a hydrodesulfurization catalyst and a hydrogen feed stream 28 at mild operating conditions. The hydrocarbon stream 30 is preferably a straight run gas oil boiling in the range of about 260° C. to about 450° C., typically containing up to about 2 weight % sulfur, although one of ordinary skill in the art will appreciated that other hydrocarbon streams can benefit from the practice of the system and method of the present invention. The hydrodesulfurization catalyst can be, for instance, an alumina base containing cobalt and molybdenum.

As will be understood by one of ordinary skill in the art, “mild” operating conditions is relative and the range of operating conditions depend on the feedstock being processed. According to the present invention, these mild operating conditions as used in conjunction with hydrotreating a mid-distillate stream, i.e., boiling in the range of about 180° C. to about 370° C., include: a temperature of about 300° C. to about 400° C., preferably about 320° C. to about 380° C.; a reaction pressure of about 20 bars to about 100 bars, preferably about 30 bars to about 60 bars; a hydrogen partial pressure of below about 55 bars, preferably about 25 bars to about 40 bars; a feed rate of about 0.5 hr⁻¹ to about 10 hr⁻¹, preferably about 1.0 hr⁻¹ to about 4 hr⁻¹; and a hydrogen feed rate of about 100 liters of hydrogen per liter of oil (L/L) to about 1000 L/L, preferably about 200 L/L to about L/L.

The resulting hydrodesulfurized hydrocarbon stream 32 is substantially free of labile organosulfur compounds including aliphatic sulfur-containing compounds and thiophenes, benzothiophenes and their derivatives. This stream 32 is passed to a flashing column 33 to be fractionated at a target cut point temperature range of about 300° C. to about 360° C., and preferably about 340° C., into two streams 34 and 35. Stream 34 boiling below the target cut point temperature, has an ultra-low level of organosulfur compounds. Stream 34 can be recovered separately or in combination with the portion boiling at or above the target cut point temperature that has been subjected to oxidative desulfurization reaction zone 36. Stream 35, which boils above the target cut point temperature, is passed to the oxidative desulfurization reaction zone 36 to be contacted with an oxidizing agent and one or more catalytically active metals. The oxidizing agent can be an aqueous oxidant such as hydrogen peroxide, organic peroxides such as ter-butyl hydroperoxide, or peroxo acids, a gaseous oxidant such as oxides of nitrogen, oxygen, or air, or combinations comprising any of these oxidants. The oxidation catalyst can be selected from one or more homogeneous or heterogeneous catalysts having metals from Group IVB to Group VIIIB of the Periodic Table, including those selected from of Mn, Co, Fe, Cr and Mo.

The higher boiling point fraction, the oxidizing agent and the oxidation catalyst are maintained in contact for a period of time that is sufficient to complete the oxidation reactions, generally about 15 to about 180 minutes, in certain embodiments about 15 to about 90 minutes and in further embodiments about 30 minutes. The reaction conditions of the oxidative desulfurization zone 16 include: an operating pressure of about 1 bar to about 80 bars, in certain embodiments about 1 bar to about 30 bars and in further embodiments at atmospheric pressure; and an operating temperature of about 30° C. to about 300° C., in certain embodiments about 30° C. to about 150° C. and in further embodiments about 80° C. The molar feed ratio of oxidizing agent to sulfur is generally about 1:1 to about 100:1, in certain embodiments about 1:1 to about 30:1, and in further embodiments about 1:1 to about 4:1. In the oxidative desulfurization zone 36, at least a substantial portion of the aromatic sulfur-containing compounds and their derivatives boiling at or above the target cut point are converted to oxidized sulfur-containing compounds, i.e. sulfones and sulfoxides, and discharged as an oxidized hydrocarbon stream 37.

Stream 37 from the oxidative desulfurization zone 36 is passed to the separation zone 38 to remove the oxidized sulfur-containing compounds as discharge stream 39 and obtain a hydrocarbon stream 40 that contains an ultra-low level of sulfur, i.e., less than 15 ppmw. Streams 34 and 40 are combined to provide a hydrocarbon product 41 that contains an ultra-low level of sulfur. Stream 39 from the separation zone 38 is passed to sulfones and sulfoxides handling unit (not shown) to recover hydrocarbons free of sulfur, for example, by cracking reactions, thereby increasing the total hydrocarbon product yield. Alternatively, stream 39 can be passed to other refining processes such as coking or solvent deasphalting.

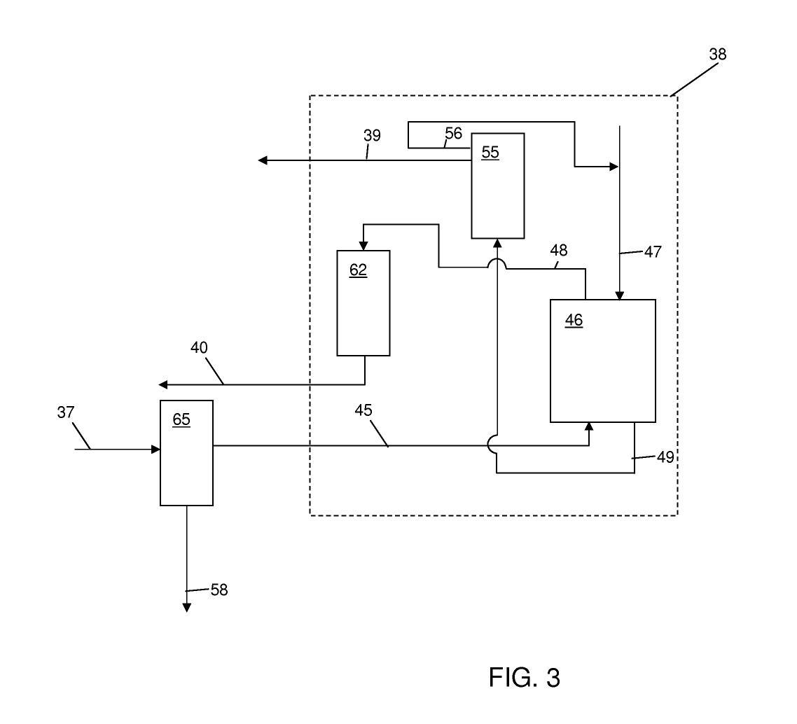

Referring to FIG. 3, one embodiment of a process for removing sulfoxides and sulfones from oxidized hydrocarbon stream 37 is shown. Stream 37 containing oxidized hydrocarbons, water and catalyst is introduced into is introduced into a decanting vessel 65 to decant water and catalyst as discharge stream 58 and separate a hydrocarbon mixture stream 45. Stream 58 which can include a mixture of water (e.g., from the aqueous oxidant), any remaining oxidant and soluble catalyst, is withdrawn from the decanting vessel 65 and recycled to the oxidative desulfurization zone 36 (not shown in FIG. 3), and the hydrocarbon stream 45 is passed generally to the separation zone 38. The hydrocarbon stream 45 is introduced into one end of a counter-current extractor 46, and a solvent stream 47 is introduced into the opposite end. Oxidized sulfur-containing compounds are extracted from the hydrocarbon stream with the solvent as solvent-rich extract stream 49.

The solvent stream 47 can include a selective solvent such as methanol, acetonitrile, any polar solvent having a Hildebrandt value of at least 19, and combinations comprising at least one of the foregoing solvents. Acetonitrile and methanol are preferred solvents for the extraction due to their polarity, volatility, and low cost. The efficiency of the separation between the sulfones and/or sulfoxides can be optimized by selecting solvents having desirable properties including, but not limited to boiling point, freezing point, viscosity, and surface tension.

The raffinate 48 is introduced into an adsorption column 62 where it is contacted with an adsorbent material such as an alumina adsorbent to produce the finished hydrocarbon product stream 40 that has an ultra-low level of sulfur, which is recovered. The solvent-rich extract 49 from the extractor 46 is introduced into the distillation column 55 for solvent recovery via the overhead recycle stream 56, and the oxidized sulfur-containing compounds, i.e., sulfones and/or sulfoxides, are discharged as stream 39.

The addition of a flash column into an the apparatus and process of the invention that integrates a hydrodesulfurization zone and an oxidative desulfurization zone uses low cost units in both zones as well as more favorable conditions in the hydrodesulfurization zone, i.e., milder pressure and temperature and reduced hydrogen consumption. Only the fraction boiling at or above the target cut point temperature is oxidized to convert the refractory sulfur-containing compounds. This results in more cost-effective desulfurization of hydrocarbon fuels, particularly removal of the refractory sulfur-containing compounds, thereby efficiently and economically achieving ultra-low sulfur content fuel products.

The present invention offers distinct advantages when compared to conventional processes for deep desulfurization of hydrocarbon fuel. For example, in certain conventional approaches to deep desulfurization, the entire hydrocarbon stream undergoes both hydrodesulfurization and oxidative desulfurization, requiring reactors of high capacity for both processes. Furthermore, the high operating costs and undesired side reactions that can negatively impact certain desired fuel characteristics are avoided using the process and apparatus of the present invention. In addition, operating costs associated with the removal of the oxidized sulfur-containing compounds from the entire feedstream are decreased as only a portion of the initial feed is subjected to oxidative desulfurization.

### Example

A gas oil fraction, the properties of which are given in Table 4, was subjected to hydrodesulfurization in a hydrotreating vessel using an alumina catalyst promoted with cobalt and molybdenum metals at 42 Kg/cm² hydrogen partial pressure at the reactor outlet, weighted average bed temperature of 332° C., liquid hourly space velocity of 3.2 h⁻¹ and hydrogen to oil ration of 300 liters/liters. The sulfur content of the gas oil was reduced to 1,100 ppmw from 11,500 ppmw.

TABLE 4

| Property | Unit | Value |
|---|---|---|
| API Gravity | ° | 35.2 |
| Carbon | W % | 85.83 |
| Hydrogen | W % | 12.85 |
| Sulfur | W % | 1.15 |
| Nitrogen | ppmw | 100 |
| ASTM D86 Distillation | | |
| IBP/5 V % | ° C. | 149/207 |
| 10/30 V % | ° C. | 234/269 |
| 50/70 V % | ° C. | 293/325 |
| 85/90 V % | ° C. | 361/379 |

The hydrotreated feedstock was fractionated in an atmospheric distillation column to split the gas oil into two fractions: A Light Gas Oil fraction (LGO) that boils at 340° C. and less and a Heavy Gas Oil fraction (HGO) that boils at 340° C. and higher were obtained. The sulfur content of the LGO fraction was less than 10 ppmw.

The hydrotreated heavy gas oil was oxidized in a vessel at 70° C. and 1 atm for 1.5 hour. 0.28 W % of Na₂WO₄, 2H₂O and 6 W % of acetic acid are used as catalytic system. A 30% H₂O₂/H₂O mixture is used as oxidizing agent at a peroxide to sulfur ratio of 4. After the oxidation reaction the reaction medium is cooled down to room temperature and the layers are separated. The oil layer that contained the oxidized sulfur-containing compounds underwent an extraction step using methanol (1:1 V/V %) at room temperature. Adsorption of remaining sulfur-containing compounds in oil layer after solvent extraction is carried out at room temperature in a chromatography column, equipped with a coarse bottom frit (10:1 ratio of oil and γ-Al₂O₃). The sulfur content of the oil layer was reduced to 10 ppmw from 1,100 ppmw.

The method and system of the present invention have been described above and in the attached drawings; however, modifications will be apparent to those of ordinary skill in the art and the scope of protection for the invention is to be defined by the claims that follow.

1. A method of processing a hydrocarbon feed to remove undesired organosulfur compounds comprising:
subjecting the hydrocarbon feed to a hydrodesulfurizing process to thereby lower the content of the labile organosulfur compounds and produce a hydrotreated effluent;
flashing the hydrotreated effluent at a temperature cut point of 320-360° C. to provide a low boiling temperature fraction that contains a reduced level of organosulfur compounds and a high boiling temperature fraction having refractory organosulfur compounds; and
separating the high and low boiling temperature fractions;
contacting the high boiling temperature fraction with an oxidizing agent and an oxidizing catalyst to convert refractory organosulfur compounds including dibenzothiophenes, alkyl derivatives of dibenzothiophenes and long-chain alkylated derivatives of benzothiophene having a boiling point in the range of the high boiling temperature fraction, to sulfoxides and/or sulfones.

2. The method of claim 1, wherein the temperature cut point is about 340° C.

3. The method of claim 1, wherein the low boiling temperature fraction includes aliphatic organosulfur compounds.

4. The method of claim 3, wherein the aliphatic organosulfur compounds include sulfides, disulfides, and mercaptans.

5. The method of claim 3, wherein the low boiling temperature fraction further includes thiophene and alkyl derivatives of thiophene.

6. The method of claim 1, wherein the high boiling temperature fraction includes dibenzothiophene, alkyl derivatives of dibenzothiophene and long-chain alkylated derivatives of benzothiophene having a boiling point in the range of the high boiling temperature fraction.

7. The method of claim 1, wherein the hydrocarbon feed is a straight run gas oil boiling in the range of about 260° C. to about 450° C.

8. The method of claim 7, wherein the hydrodesulfurizing process is operated at mild operating conditions.

9. The method of claim 8, wherein the hydrogen partial pressure is less than about 55 bars.

10. The method of claim 8, wherein the hydrogen partial pressure is about 25 bars to about 40 bars.

11. The method of claim 8, wherein the operating temperature is about 300° C. to about 400° C.

12. The method of claim 8, wherein the operating temperature is about 320° C. to about 380° C.

13. The method of claim 8, wherein the hydrogen feed rate in the hydrodesulfurizing process step is from about 100 liters of hydrogen per liter of oil to about 1000 liters of hydrogen per liter of oil.

14. The method of claim 8, wherein the hydrogen feed rate in the hydrodesulfurizing process step is from about 200 liters of hydrogen per liter of oil to about 300 liters of hydrogen per liter of oil

15. The method of claim 1, wherein the oxidizing agent is selected from the group consisting of hydrogen peroxide, organic peroxides such as ter-butyl hydroperoxide, peroxo acids, oxides of nitrogen, oxygen, and air.

16. The method of claim 1, wherein the oxidizing catalyst is selected from the group consisting of homogeneous catalysts and heterogeneous catalysts.

17. The method of claim 16, wherein the oxidizing catalyst includes a metal from Group IVB to Group VIIIB of the Periodic Table.

18. The method of claim 1, further comprising separating the oxidizing agent and oxidizing catalyst from the high boiling temperature fraction following the reaction.

19. The method of claim 18, wherein the oxidizing agent is separated by solvent extraction.

20. The method of claim 1, further comprising recovering a hydrotreated hydrocarbon product.

21. The method of claim 1, further comprising recovering a hydrocarbon product subjected to oxidative desulfurization.

22. The method of claim 1, further comprising combining the low boiling temperature fraction that has been subjected to a hydrodesulfurization process and the high boiling temperature fraction that has been subjected to oxidative desulfurization into a reduced-organosulfur content hydrocarbon product.

23. An apparatus for processing a hydrocarbon feed containing undesired organo sulfur compounds comprising:
a hydrodesulfurization zone having an inlet in fluid communication with the hydrocarbon feed and an outlet for discharging hydtrotreated effluent;
a flashing column operable to flash the hydtrotreated effluent at a temperature cut point of about 320° C. to about 360° C., the flashing column including
an inlet for receiving the hydtrotreated effluent,
a low boiling temperature outlet for discharging a low boiling temperature fraction, and
a high boiling temperature outlet for discharging a high boiling temperature fraction containing refractory organosulfur compounds;
an oxidative desulfurization zone containing an oxidation catalyst and an oxidizing agent, oxidative desulfurization zone having an inlet in fluid communication with the high boiling temperature outlet and an outlet for discharging oxidized effluent.
